(19) United States
(12) Patent Application Publication
(10) Pub. No.: US 2007/0211148 A1
(43) Pub. Date: Sep. 13, 2007

(54) System and method for providing added utility to a video camera

(76) Inventors: Yossi Lev, Ramat Gan (IL); Mendy Mendelsohn, Jerusalem (IL); Yaacov Ben Yaacov, Jerusalem (IL)

Correspondence Address: Christopher J. McDonald;HOFFMAN, WASSON & GITLER, P.C., Suite 522, 2461 South Clark Street, Arlington, VA, 22202, US

(21) Appl. No.: 11/709,143

(22) Filed: Feb. 22, 2007

Related U.S. Application Data
(63) Continuation of application No. 09/648,426, filed on Aug. 28, 2000, now abandoned.

(51) Int. Cl. H04N 5/225

(52) U.S. Cl. 348/207.99; 348/E05.024

(57) ABSTRACT

A system and method for providing added utility to at least one video camera. The system includes the camera, a device capable of communication and at least one processing device. The camera contains a memory device capable of storing captured video containing visually perceptible data. The device capable of communication is for receiving video containing visually perceptible data and is further capable of transmitting visually perceptible data through a channel of communication. The at least one processing device adds utility to the visually perceptible data. The method for providing added utility to at least one video camera includes the step of capturing and storing video containing visually perceptible data and the step of transmitting visually perceptible data through a channel of communication and the step of receiving video containing visually perceptible at a device capable of communication and the step of processing the video containing visually perceptible data to add utility thereto.

### FIELD AND BACKGROUND OF THE INVENTION

The present invention relates to a system and method for providing added utility to at least one video camera and, more particularly, to a system and method for modifying visually perceptible data captured by the camera.

Rapid transmission of information in various forms from one place to another has become increasingly more sophisticated since the invention of the telegraph. Invention of the telephone made transfer of information in an easily recognizable format a reality.

Subsequent advances in technology have created an increasing demand for both access to information and portability of devices for information capture and transfer.

For example, a fax machine makes transfer of a copy of a document easy, but the machine is typically not easily portable. Although portable wireless fax machines (e.g. Possio's PM70, Täby, SWEDEN) and portable scanning devices do exist (e.g. HP's CapShare, Palo Alto, Calif., or Wizcom's QuickLink/Quicktionary, Jerusalem, ISRAEL), these devices are dedicated devices with a narrowly defined function. The fact that a user must carry a separate device for each function is a distinct disadvantage.

Similarly, flatbed scanners made capture and transmission of photographic images a realistic possibility. These devices have already been replaced, in some instances, with digital still or video cameras which allow direct transfer of a photographic image to a computer where they may be either stored or transferred. Currently, the main drawback to digital cameras is the typically low resolution offered by lower priced models.

In addition, there is an increasing demand for transfer of information from point of capture to a remote location, so that transfer would be independent of arrival at specific locations where specialized hardware is available.

U.S. Pat. No. 5,262,860 teaches a system and method for capturing and processing visual perceptible data within broadcast video signals. Teachings of this patent specifically require use of a television receiver to receive a broadcast video signal. Implicit in this requirement is the idea that broadcast occurs in the UHF or VHF wavelengths. Use of telephony, whether cellular or conventional, to transmit a video signal or data derived therefrom is not taught by this patent.

There is thus a widely reed need for, and it would be highly advantageous to have, a system and method for providing added utility to-at least one video camera devoid of the above limitations.

### SUMMARY OF THE INVENTION

According to one aspect of the present invention there is provided a method for providing added utility to at least one video camera. The method includes the steps of: (a) capturing and storing at least one frame of video containing visually perceptible data by the at least one video camera (b) opening at least one channel of communication and transmitting therethrough the visually perceptible data; (c) receiving the at least one frame of video containing visually perceptible data by at least one device capable of communication; and (d) processing the at least one frame of video containing visually perceptible data so that the processed data acquires added utility.

According to another aspect of the present invention there is provided a system for providing added utility to at least one video camera. The system includes: (a) the at least one video camera containing a memory device capable of at least transiently storing at least one frame of captured video containing visually perceptible data; (b) at least one device capable of communication, the at least one device capable of communication being designed and configured for receiving the at least one frame of video containing visually perceptible data, the at least one device capable of communication being further capable of opening at least one channel of communication and transmitting therethrough the visually perceptible data; and (c) at east one processing device designed and configured to process the visually perceptible data so that the processed data acquires added utility.

According to further features in preferred embodiments of the invention described below, the visually perceptible data includes at least one item selected from the group consisting of at least a portion of a printed document, a bar-code and an image of at least a portion of a person.

According to still further features in the described preferred embodiments the step of processing occurs during at least one time selected from the group consisting of prior to transmitting through the at least one channel of communication, concurrent with transmission through the at least one channel of communication, and after transmission through the at least one channel of communication.

According to still further features in the descried preferred embodiments the at least one device capable of communication is at least one device selected from the group consisting of an internet server, a telephone, a cellular telephone, a smart phone, a personal computer and a web TV.

According to still further features in the described preferred embodiments the step of processing includes at least one sub-step selected from the group consisting of resolution enhancement, mosaicing, optical character recognition, text to speech transformation, decoding of a barcode, recognition of at least a portion of a person, detection of visually perceptible motion, merging of at least two video stream, fusing of at least two images to create a panoramic image, adding at least one item of information pertaining to time and addition of visually perceptible features.

According to still further features in the described preferred embodiments the method is employed to create a legible image of at least a portion of a document.

According to still further features in the described preferred embodiments the substep of optical character recognition is employed to generate an editable text document from an image.

According to still further features in the described preferred embodiments the substep of decoding of a barcode is employed to identify a product.

According to still further features in the described preferred embodiments the sub-step of recognition of at least a portion of a person is employed to establish an identity of the person.

According to still further features in the described preferred embodiments the substep of detection of visually perceptible motion is employed to identify important portions of the at least one frame of video.

According to still fire features in the described preferred embodiments the substep of merging of at least two data streams is employed to facilitate simultaneous display of the at least two data streams on a single display device.

According to still further features in the described preferred embodiments the sub-step of addition of visually perceptible features is employed to perform an action selected from the group consisting of to advertise, to include additional items, to alter a color, to adjust brightness, to adjust contrast to superimpose at least a portion of one frame of video upon at least a portion of a second frame of video and to alter a background.

According to still further features in the described preferred embodiments the method further includes the step of transmitting the legible image of at least a portion of a document.

According to still further features in the described preferred embodiments the method further includes transmission of the editable text document to at least one of the at least one device capable of communication.

According to still further features in the described preferred embodiments the method further includes at least one additional step selected from the group consisting of conducting a search to determining at least one price of the product, conducting a search to determine availability of the product and purchasing the product.

According to still further features in the described preferred embodiments the method further includes the step of controlling access based upon the established identity.

According to still further features in the described preferred embodiments the method further includes the step of taking at least one action selected from the group consisting of storing the important portions of the at least one frame of video, transmitting the important portions of the at least one frame of video to the at least one device capable of communication and issuing an alert.

According to still further features in the described preferred embodiments the simultaneous display is used to facilitate a video conference.

According to still further features in the described preferred embodiments the at least one processing device processes the at least one frame of video containing visually perceptible data in at least one location selected from the group consisting of in the at least one video camera and in at least one of the at least one device capable of communication.

According to still further features in the described preferred embodiments decoding of a barcode is employed to identify a product.

According to still further features in the described pored embodiments the system further includes a searchable database of images of at least a portion of a person, the database employable to establish an identity of the person.

According to still further features in the described preferred embodiments the system further includes a searchable database for determining price and availability of the product.

According to still further features in the described preferred embodiments the system further includes a mechanism for facilitating purchase of the product.

According to still further features in the described preferred embodiments the system further includes a mechanism for controlling access based upon the established identity.

According to still further features in the described preferred embodiments the system further includes at least one item selected from the group consisting of a memory device designed and configured for storing the important portions of the at least one frame of video, a mechanism for selectively transmitting the important portions of the at least one frame of video to the at least one device capable of communication and a mechanism for issuing an alert.

The present invention successfully addresses the shortcomings of the presently known configurations by providing a system and method for providing added utility to at least one video camera so that modifying visually perceptible data captured by the camera allows use of the at least one camera in a wide range of applications.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illusive discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a diagrammatic representation of a system according to the present invention; and

FIG. 2 is a flow diagram of a method according to the present invention.

### DESCRIPTION OF THE PREFERRED EMBODIMENTS

The present invention is of a system and method for providing added utility to at least one video camera which can be employed to modify visually perceptible data captured by the camera.

Specifically, the present invention can be used to add a wide range of capabilities to a video capture device by allowing it to communicate with other devices.

The principles and operation of a system and method for providing added utility to at least one video camera according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims, the phrase “video camera” refers to any camera capable of capturing at least one video image. This definition specifically includes, but is not limited to a webcam, a wireline or wireless videophone, a digital camera (e.g. digital still camera, digital video camera) and a conventional video camera.

For purposes of this specification and the accompanying claims, the phrase “printed document” refers also to written documents.

For purposes of this specification and the accompanying claims, the phrase “channel of communication” refers to a telephone connection, a cellular telephone connection, a wireless telephone connection, an internet connection, an infrared frequency transmission connection, a local area network connection, a radio frequency connection, a fiber-optic connection, a connection by a wire, connection of components in an electrical device, connections in electrical or silicon circus or a connection by means of shared (computer) memory. Specifically excluded from this definition are radio broadcasts in the portions of the UHF and VHF bands generally reserved for television broadcast. Inherent in the idea of a communication channel is an open status during which data transmission may occur. In some cases, communication channels may also have a closed status during which no data transmission may occur.

For purposes of this specification and the accompanying claims, the term “concurrent” shall be construed to mean at approximately the same time. Therefore “immediately before”, “immediately after” and “at the same time” are equivalent to concurrent. Concurrency may be said to occur, for example, when streaming technology is employed to transfer a computer file. In cases where a file is being processed and a processed portion is streamed while an unprocessed portion remains, or in cases where an incoming file stream is processed before the entire file is received, processing is “concurrent with transmission”.

For purposes of this specification and the accompanying claims a “device capable of communication” is any device capable of transmitting through a channel of communication in any form. These devices may further possess data storage capacity. Examples of a device capable of communication include, but are not limited to, an internet server, a telephone, a cellular telephone, a smart phone, a personal computer and a web TV. The term personal computer, as used herein, refers also to personal digital assistants.

For purposes of this specification and the accompanying claims the phrase “data stream” includes, but is not limited to data in the process of being transferred. Video streams are included within data streams, but many non-video data streams exist. It will be appreciated that data within a stream may have a different format than the same data before it enters the stream or after it leaves the stream. For example, e-mail messages including text are transmitted in ASCII format despite the fact that the sender and recipient both see text. The same holds true for e-mail attachments, including, but not limited to, graphics files. Documents transmitted to a facsimile machine are also in a different format during transmit.

For purposes of this specification and the accompanying claims, the phrase “video stream” includes, but is not limited to a video film, a single still image and a series of at least two still images. Further included in this definition are any computer file, whether uncompressed or compressed, that can be displayed upon a display device as at least one image, more preferably as at least two images, most preferably as an animated sequence of images. A video stream may be immediately transmitted, stored within a memory component of a device, or stored upon a tangible media. This storage may be either transient or permanent.

For purposes of this specification and the accompanying claims the phrase “display device” refers to any device for presentation of data to a user. The definition includes, but is not limited to speakers, earphones, LCD screens, LED displays, CRT displays and active matrix displays.

The phrase “tangible media” as used in this specification and the accompanying claims includes, but is not limited to, a CD ROM disc, a computer diskette, a computer disk, a magneto-optical cartridge, a ZIP™ disc, a JAZZ™ disc, a card bearing a magnetic stripe, magnetic tape and any other physical entity bearing digitally encoded data.

For purposes of this specification and the accompanying claims, the term “alert” includes, but is not limited to, sending an e-mail message, transiting data to an alphanumeric pager, initiating a phone call, transmission of a text message to a telephone, transmission of a facsimile document to a facsimile machine operation of an audible device (e.g. siren, bell, whistle), issuance of a computer alert warning of a weapon and locking of a lock.

For purposes of this application and the accompanying claims the phrase “standard file format” refers to any format for storing on a computing machine or transmitting digital data between computing machines. This definition includes, but is not limited to, Raw File Format, SciTex Continuous Tone, Sun Raster Image, Tagged Image File Format, Truevision Targa, Windows Clipboard, Windows Enhanced Meta File, Windows Meta File, RLE files, Bitmap (.bmp and .wpg), DIB files, Zsoft Paintbrush, Microsoft Paint, Paint Shop Pro Image, .pic files (e.g. PC Paint), Photoshop, Portable Bitmap, Portable Greymap, Portable Network Graphics, Portable Pixelmap, Amiga, Graphics Interchange Format, Deluxe Paint, Dr. Halo, Encapsulated PostScript, FlashPix, GEM paint, JPEG-JFIF Compliant, Macintosh PICT, GIF and Mac Paint.

For purposes of this application and the accompanying claims the phrase “legible image of at least a portion of a document” refers to any electronically transmissible or printable image which would be legible to a person with normal visual acuity. Such a legible image might be, for example, in a standard file format. Transmission might occur, for example, via a fax protocol to a fax machine or as an e-mail attachment.

For purposes of this application and the accompanying claims the term “document” refers to both items printed on paper or a similar surface and to items capable of being printed on paper or a similar surface. Specifically included in this definition are text, pictures, graphics and any combination thereof.

For purposes of this application and the accompanying claims the phrase “visually perceptible data” refers to any data which is visually perceptible or is translatable into a visually perceptible format. Specifically included in this definition are fax messages, which are not visually perceptible in transmit, but are visually perceptible to the sender and the recipient. Similarly, email messages which are in ASCII format during transfer are included in this definition.

For purposes of this specification and the accompanying claims, the term “server” refers to any computing machine capable of exchanging data with at least one other computing machine. A single server may comprise an individual computing machine or a plurality of such machines acting in concert to perform a function requested by at least one other computing machine.

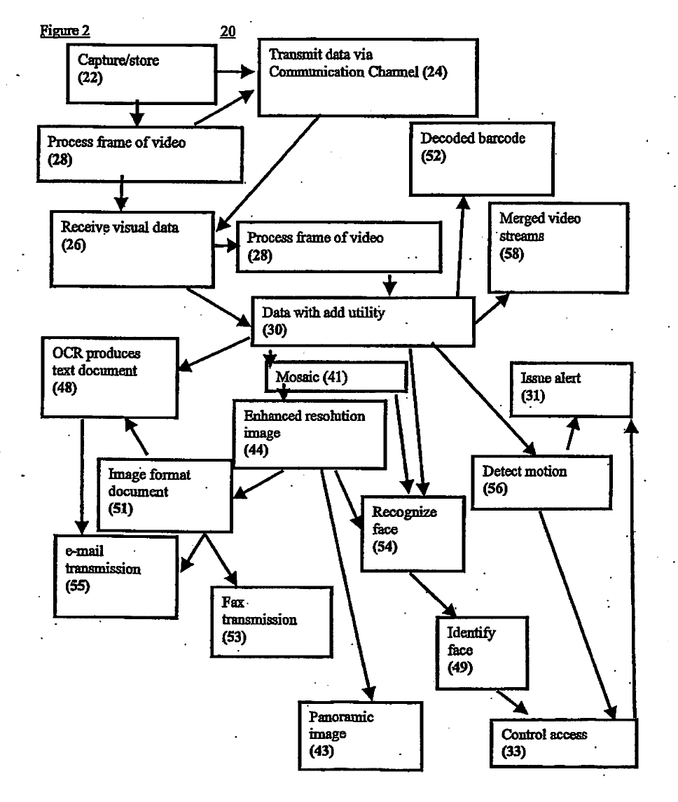

Referring now to the drawings, FIG. 2 illustrates the method 20 for providing added utility to at least one video camera. The method includes at least four steps.

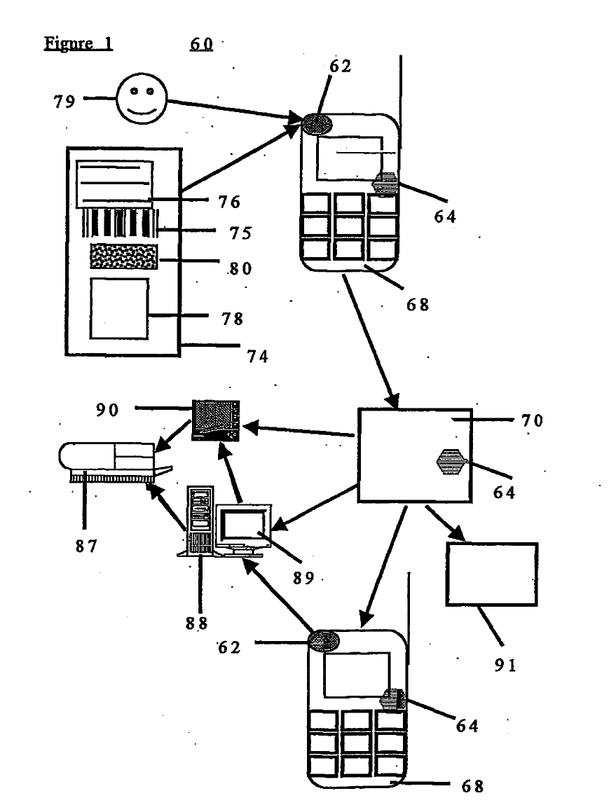

The fast step 22 includes capturing and storing at least one frame of video containing visually perceptible data by the at least one video camera 62 (FIG. 1). visually perceptible data may include, for example, at least a portion of a printed document 74, a bar-code 75, or an image of at least a portion of a person 79.

The second step 24 includes opening at least one channel of communication (arrows in FIGS. 1 and 2) and transmitting therethrough the visually perceptible data.

The third step includes receiving 26 the at least one frame of video containing visually perceptible data by at least one device capable of communication (e.g. server 70). The at least one device capable of communication may be, for example, an internet server 70, a telephone, a cellular telephone 68, a smart phone, a personal computer 88, personal digital assistant (PDA) 90, or a web TV.

The fourth step includes processing the at least one frame of video containing visually perceptible data so that the processed data acquires added utility 30. According to preferred embodiments of the invention the step of processing may occur, for example, prior to transmitting 24 through the at least one channel of communication, concurrent with transmission 24 through the at least one channel of communication, or after transmission 24 through the at least one channel of communication. This means that portions of processing 28 may be conducted in, for example, camera 62, cell phone 68, server 70, computer 88, or personal digit assistant 90. Alternately or additionally, processing may be a multistep event, each step occurring at a different time. The step of processing may include, for example, resolution enhancement 44, mosaicing 41, optical character recognition 48, text to speech transformation, decoding of a barcode 52, recognition of at least a portion of a person 54, detection of visually perceptible motion 56, merging of at least two video streams 58, fusing of at least two images to create a panoramic image 43, adding at least one item of information pertaining to time, addition of visually perceptible features or any combination thereof.

Method 20 may be employed, for example to create a legible image (48 or 51) of at least a portion of a document 74. This may involve the sub-step of optical charter recognition 48 to generate an editable text document from an image.

According some preferred embodiments the sub-step of decoding of a barcode 52 is employed to identify a product. This capacity will allow conducting a search to determine at least one price of the product, conducing a search to determine availability of the product or purchase the product.

According to some preferred embodiments the sub-step of recognition of at least a portion of a person 54 is employed to establish an identity of the person 49. This identification is useful for controlling access 33 based upon the established identity. Access control might be used, for example, to verify the identity of a holder of an ATM card, or of an employee ID card, of a driver of a car. Such an identification system might operate independently.

According to still further features in the described preferred embodiments the sub-step of detection 56 of visually perceptible motion is employed to identify important portions of the at least one frame of video.

Method 20 may further include the step of storing the important portions of the at least one frame of video, transmitting the important portions of the at least one frame of video to the at least one device capable of communication, issuing an alert or any combination thereof.

According to still further features in the described preferred embodiments the substep of merging of at least two data streams is employed to facilitate simultaneous display of the at least two data streams on a single display device such as, for example cellular phone 68 or display 89 of computer 88. The simultaneous display can be used to facilitate, for example, a videoconference.

Addition of visually perceptible features may be employed, for example, to advertise, to include additional items, to alter a color, to adjust brightness, to adjust contrast, to superimpose at least a portion of one frame of video upon at least a portion of a second frame of video and to alter a background. These capabilities can facilitate, for example, virtually trying on new clothing prior to purchase and virtual testing of a new hairstyle.

Method 20 may further includes the step of transmitting the legible image 44 of at least a portion of a document by, for example, fax 53 or e-mail 55. Alternately or additionally, method 20 further includes transmission of the editable text document to at least one of the at least one device capable of communication as defined hereinabove. Such transmission may be, for example, in a standard file format as defined hereinabove. This may be for an end use or for further processing.

The present invention is further embodied by a system 60 for providing added utility to at least one video camera 62. System 60 includes at least 3 components.

The first component includes video camera 62 containing a memory device 64 capable of at least transiently storing at least one frame of captured video containing visually perceptible data. The captured data may include, for example text 76, a bar code 75, aperture 80, an image 78, or an image of at least a portion of a person, such as face 79.

The second component includes at least one device capable of communication such as cell phone 68. The at least one device capable of communication is designed and configured for receiving the at least one frame of video containing visually perceptible data. The at least one device capable of communication may be either physically connected to camera 62 (for example phone 68), or connected to camera 62 by a channel of communication (arrows) such as server 70, or by a channel of communication and one or more intermediate devices such as computers 88, PDA 90 and printer 87.

The at least one device capable of communication is further capable of opening at least one channel of communication and transmitting therethrough the visually perceptible data. In some cases, the transmitted data will be a video steam, in some cases it will be processed data and the transmission will be a non-video data stream.

The third component includes at least one processing device (e.g. server 70 or computer 88) designed and configured to process the visually perceptible data so that the processed data acquires added utility. The at least one processing device may process the at least one frame of video containing visually perceptible data for example in the at least one video camera or in at least one of the at least one device capable of communication. This processing may result in, for example decoding 52 of a barcode 75 in order to identify a product. System 60 may further include a searchable database for determining price and availability of the product and a mechanism for facilitating purchase of the product.

System 60 may fifth include a searchable database of images of at least a portion of a person, the database employable to establish an identity of the person. System 60 may further include a mechanism for controlling access 91, as detailed hereinabove, based upon the established identity. A number of mechanisms for identification of a face or a portion thereof are taught by the prior art, for example those disclosed in U.S. Pat. Nos. 4,449,189 and 5,956,482 and references cited therein. One ordinarily skilled in the art will be capable of integrating such a facial recognition system into the system or method of the present invention.

The searchable databases referred to hereinabove will most commonly reside in memory 64 of server 70 although they could conceivably be stored elsewhere, such as in computer 88 or camera 62 or telephone 68.

Visually detectable motion may be used to define important portions of the video system. System 60 may further include, for example, a memory device designed and configured for storing the important portions of the at least one frame of video, a mechanism for selectively transmitting the import portions of the at least one frame of video to the at least one device capable of communication and a mechanism for issuing an alert.

As an illustrative example of the present invention, Max Marx goes shopping for a hat. He finds a fedora that he likes in a department store. The price tag is 175$. Max aims camera 62 of his cellphone 68 at barcode 75 on the price tag of the hat. Barcode information is captured 22 and stored as at least one frame of video in memory 64 of phone 68. According to some embodiments, part of processing 28 may occur in phone 68. According to other embodiments, processing 28 occurs in server 70. Transmission 24 to server 70 occurs during a phone call initiated by Max. Memory 64 of server contains a database of price information linked to store names and locations Max's cell phone is equipped with a GPS device which tells the system his approximate geographic location. Several minutes later, Max receives a text message on phone 68 listing prices and phone numbers. The lowest price for the hat he has selected is 69$. He calls the shop and discovers they are only 4 blocks from where he is standing. He tells them his hat size and completes the purchase by credit card on phone 68. His new hat is delivered to his home later that day.

As a second illustrative example of the present invention, on his way home, Max stops at an ATM machine to withdraw cash. The security camera 62 in the ATM machine captures 22 a video image of Max and transmits 34 the image to server 70. Server 70 processes 28 the data to recognize 54 the portion of the frame containing Max's face and compares the face to a video image of max captured when his card was issued. Max's identity is verified 49 and access 33 to cash is granted.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirely by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method for providing added utility to at least one video camera, said method comprising:
capturing and storing a plurality of frames of video containing visually perceptible data in the form of a bar code by the at least one video camera;
opening at least one channel of communication and transmitting therethrough said visually perceptible data;
receiving said plurality of frames of video containing visually perceptible data by at least one device capable of communication; and
processing said plurality of frames of video containing visually perceptible data so that the processed data acquires added utility,
said processing including decoding of said bar code, and
said at least one video camera being permanently attached to a cellular telephone.

2. The method of claim 1, wherein said processing occurs during at least one time selected from the group consisting of prior to transmitting through said at least one channel of communication, concurrent with transmission through said at least one channel of communication, and after transmission through said at least one channel of communication.

3. The method of claim 1, wherein said at least one device capable of communication is at least one device selected from the group consisting of an internet server, a telephone, a cellular telephone, a smart phone, a personal computer and a web TV.

4. The method of claim 1, wherein said processing includes resolution enhancement.

5. The method of claim 4 wherein said processing includes mosaicing.

6. The method of claim 1, wherein said decoding of said barcode is employed to identify a product.

7. The method of claim 6, further comprising at least one additional step selected from the group consisting of:
conducting a search to determine at least one price of said product;
conducting a search to determine availability of said product; and
purchasing said product.

8. A system for providing added utility to at least one video camera, said system comprising:
the at least one video camera containing a memory device capable of at least transiently storing at least one frame of captured video containing visually perceptible data in the form of a barcode;
at least one device capable of communication, said at least one device capable of communication being designed and configured for receiving said at least one frame of video containing visually perceptible data, said at least one device capable of communication being further capable of opening at least one channel of communication and transmitting therethrough said visually perceptible data; and
at least one processing device designed and configured to process the visually perceptible data so that the processed data acquires added utility,
said at least one processing device being operative to decode said barcode, and
said at least one video camera being permanently attached to a cellular telephone.

9. The system of claim 8, wherein said at least one processing device processes said at least one frame of video containing visually perceptible data in at least one location selected from the group consisting of in the at least one video camera and in at least one of said at least one device capable of communication.

10. The system of claim 8, wherein said at least one device capable of communication includes at least one device selected from the group consisting of an internet server, a telephone, a cellular telephone, a smart phone, a personal computer and a web TV.

11. The system of claim 8, wherein said processing device performs resolution enhancement.

12. The system of claim 8, wherein decoding of said barcode is employed to identify a product.

13. The system of claim 12, further comprising a searchable database for determining price and availability of said product.

14. The system of claim 13, further comprising a mechanism for facilitating purchase of said product.

15. The system of claim claim 11 wherein said processing device performs mosaicing.
